(19) United States
(12) Patent Application Publication
(10) Pub. No.: US 2008/0305437 A1
(43) Pub. Date: Dec. 11, 2008

(54) MULTI-LAYER MASK METHOD FOR PATTERNED STRUCTURE ETHCING

(75) Inventors: Nicholas C.M. Fuller, Ossining, NY (US); Michael A. Guillorn, Yorktown Heights, NY (US); Francois Pagette, Jefferson Valley, NY (US); Balasubramanian Pranatharthiharan, Waterliet, NY (US); Ying Zhang, Yorktown Heights, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/760,992

(22) Filed: Jun. 11, 2007

(51) Int. Cl. G03C 5/00

(52) U.S. Cl. 430/319; 430/323

(57) ABSTRACT

A method for forming a patterned structure within a microelectronic structure uses a non-directly imageable organic material layer located over a substrate and a directly imageable inorganic material layer located upon the non-directly imageable organic material layer. The directly imageable inorganic material layer is directly imaged to form a patterned inorganic material layer. The patterned inorganic material layer is used as a first etch mask within a first etch method that etches the non-directly imageable organic material layer to form a patterned organic material layer. At least the patterned organic material layer is used as a second etch mask within a second etch method that etches the substrate to form a patterned structure within the substrate.

### BACKGROUND

1. Field of the Invention

The invention relates generally to methods for forming patterned layers and patterned structures that comprise microelectronic structures. More particularly, the invention relates to methods for efficiently forming patterned layers and patterned structures that comprise microelectronic structures.

2. Description of the Related Art

Generally, semiconductor devices include a plurality of circuits which form an integrated circuit (IC) including, for example, chips, thin film packages and printed circuit boards. ICs can be useful for computers and electronic equipment and can contain millions of transistors and other circuit elements that are fabricated within and upon a single semiconductor substrate.

For a field effect device to be functional, a gate conductor of a pFET and/or an nFET typically has a minimal line edge roughness (LER) and a minimal line width roughness (LWR) so as to enable faster devices and ring oscillators. The term “ring oscillators” refers to a series of inverters, an aggregate speed of which ultimately determines a clock speed of an integrated circuit. In the case of a polysilicon based gate conductor, a minimal LER of about 3 nm and a minimal LWR of about 3 nm are obtained for conventional CMOS processing.

For current 65 nm CMOS devices, polysilicon gates of 100 nm thickness and 40 nm critical dimension (CD) are employed. For future technologies whereby continued device scaling provides one methodology of achieving higher speed oscillators and circuits, it is essential that processing methodologies are developed to facilitate gates that have a thickness of less than 100 nm and a CD of less than 40 nm with a minimal LER and a minimal LWR.

Conventionally, gate conductors, including polysilicon gate conductors, are patterned from a gate conductor material layer that is located upon a gate dielectric material layer that in turn is located upon a semiconductor substrate. The patterning is effected using a patterned photoresist layer located over the gate conductor material layer, and an anti-reflective coating material layer located interposed between the patterned photoresist layer and the gate conductor material layer. Patterning of the gate conductor is achieved by first trimming the anti-reflective coating material layer, and then utilizing an etching process which selectively removes portions of the underlying gate conductor material layer. Unfortunately, this particular method for gate conductor patterning often yields an undesirable LER and an undesirable LWR in accordance with the above disclosed limits for those parameters. Due to the undesirable LER and the undesirable LWR, desirable are alternative methods and materials for gate conductor patterning.

Microelectronic structure and device dimensions, including in particular semiconductor structure and device dimensions, are certain to continue to decrease as semiconductor technology advances. Thus, desirable are methods for efficiently forming patterned layers and patterned structures within semiconductor and microelectronic structures, and in particular gate electrodes within field effect transistors within semiconductor structures, with improved properties and enhanced performance.

### SUMMARY OF THE INVENTION

The invention provides a method for forming a patterned structure within a microelectronic structure. To form such a patterned structure, the invention uses a non-directly imageable organic material layer located over a substrate, and a directly imageable inorganic material layer located upon the non-directly imageable organic material layer. Within the instant method, the directly imageable inorganic material layer is directly imaged to form a patterned inorganic material layer that is used as a first etch mask within a first etch method for etching the non-directly imageable organic material layer to form a patterned organic material layer. At least the patterned organic material layer is used as a second mask within a second etch method for etching the substrate to form a patterned substrate.

The substrate patterned in accordance with the invention has a negligible LER and a negligible LWR. A negligible LER and a negligible LWR imply that a 3σ variation in a gate conductor CD or an alternative patterned structure CD is much less than 3 nm (i.e., typically less than about 1-2 nm). Patterned layers and patterned structures that are patterned in accordance with the invention, such as but not limited to gate conductors (i.e., gate electrodes), enable higher speed ICs and ring oscillators.

Within the inventive method, the non-directly imageable organic material layer comprises any organic material such as, for example, a near frictionless carbon (NFC) material, a diamond-like carbon material, or a thermosetting polyarylene ether material. The term “polyarylene” is used in this application to denote aryl moieties or inertly substituted aryl moieties which are linked together by bonds, fused rings, or inert linking groups such as, for example, oxygen, sulfur, sulfone, sulfoxide, carbonyl and the like.

A particular method in accordance with the invention includes successively layering a directly non-imageable organic material layer upon a substrate and a directly imageable inorganic material layer upon the directly non-imageable organic material layer. This particular method also includes directly imaging the directly imageable inorganic material layer to form a patterned inorganic material layer. This particular method also includes using the patterned inorganic material layer as a first mask within a first etch method to etch the directly non-imageable organic material layer to form a patterned organic material layer. This particular method also includes using at least the patterned organic material layer as a second mask within a second etch to etch the substrate and form a patterned substrate.

Another particular method in accordance with the invention includes successively layering a non-directly imageable organic material layer over a gate electrode material layer located over a substrate and a directly imageable inorganic material layer upon the non-directly imageable organic material layer. This other method also includes directly imaging the directly imageable inorganic material layer to form a patterned inorganic material layer. This other method also includes using the patterned inorganic material layer as a first mask within a first etch method for etching the directly non-imageable organic material layer to form a patterned organic material layer. This other method also includes using at least the patterned organic material layer as a second etch mask within a second etch method for etching the gate electrode material layer to form a gate electrode.

Yet another particular method in accordance with the invention includes successively layering a directly non-imageable organic material layer upon a semiconductor substrate and a directly imageable inorganic material layer upon the directly non-imageable organic material layer. This yet another method also includes directly imaging the directly imageable inorganic material layer to form a patterned inorganic material layer. This yet another method also includes using the patterned inorganic material layer as a first mask within a first etch method to etch the directly non-imageable organic material layer to form a patterned organic material layer. This yet another method also includes using at least the patterned organic material layer as a second mask within a second etch to etch the semiconductor substrate to form an isolation trench within the semiconductor substrate.

### BRIEF DESCRIPTION OF THE DRAWINGS

The objects, features and advantages of the invention are understood within the context of the Description of the Preferred Embodiments, as set forth below. The Description of the Preferred Embodiments is understood within the context of the accompanying drawings, which form a material part of this disclosure, wherein:

FIG. 1 to FIG. 6 show a series of schematic cross-sectional diagrams illustrating the results of progressive stages in fabricating a semiconductor structure in accordance with a particular embodiment of the invention.

FIG. 7 to FIG. 11 show a series of schematic cross-sectional diagrams illustrating the results of progressive stages in fabricating a semiconductor structure in accordance with another particular embodiment of the invention.

### DESCRIPTION OF THE PREFERRED EMBODIMENTS

The invention, which provides a method for forming a patterned layer or a patterned structure within a microelectronic structure and in particular a semiconductor structure, is understood within the context of the description that follows. The description that follows is understood within the context of the drawings described above. Since the drawings are intended for illustrative purposes, the drawings are not necessarily drawn to scale.

While the preferred embodiments of the invention illustrate the invention within the context of patterning: (1) a gate electrode from a gate electrode material layer located over a substrate; or (2) an isolation trench within a semiconductor substrate, neither the embodiments nor the invention are necessarily so limited. Rather, the embodiments and the invention are applicable for forming within microelectronic structures and semiconductor structures patterned layers and patterned structures including but not limited to patterned conductor layers and structures, patterned semiconductor layers and structures, and patterned dielectric layers and structures.

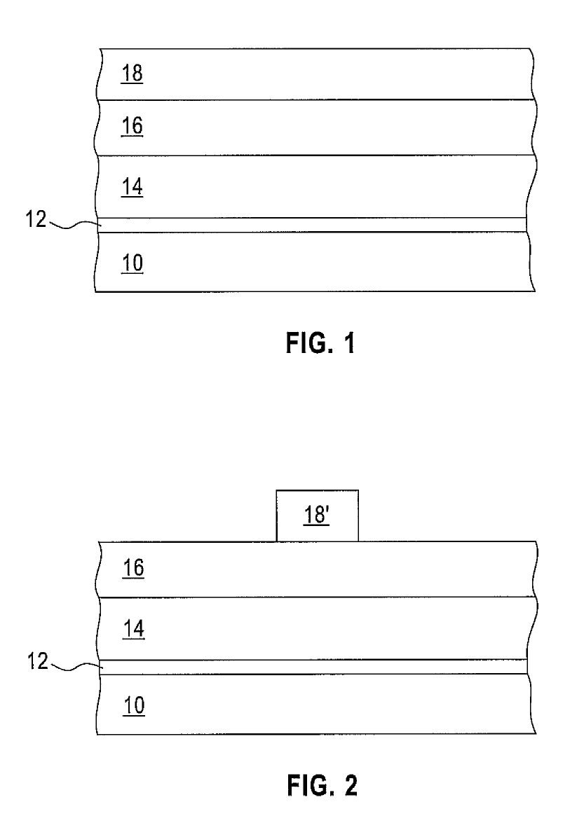

FIG. 1 to FIG. 6 show a series of schematic cross-sectional drawings illustrating the results of progressive stages in fabricating a semiconductor structure in accordance with a particular embodiment of the invention. This particular embodiment of the invention comprises a first embodiment of the invention. FIG. 1 shows a schematic cross-sectional diagram of the semiconductor structure at an early stage in the fabrication thereof in accordance with this first embodiment.

FIG. 1 shows a semiconductor substrate 10. A gate dielectric 12 is located upon the semiconductor substrate 10. A gate electrode material layer 14 is located upon the gate dielectric 12. A non-directly imageable organic material layer 16 is located upon the gate electrode material layer 14. A directly imageable inorganic material layer 18 is located upon the non-directly imageable organic material layer 16. Each of the foregoing semiconductor substrate 10 and overlying layers 12/14/16/18 may comprise materials, have dimensions and be formed using methods that are otherwise generally conventional in the semiconductor fabrication art.

For example, the semiconductor substrate 10 may comprise any of several semiconductor materials. Non-limiting examples include silicon, germanium, silicon-germanium alloy, silicon-carbon alloy, silicon-germanium-carbon alloy, and compound (i.e., III-V and II-VI) semiconductor materials. Non-limiting examples of compound semiconductor materials include gallium arsenide, indium arsenide and indium phosphide semiconductor materials. Typically, the semiconductor substrate 10 has a generally conventional thickness from about 1 to about 3 mils.

Although the instant embodiment illustrates the invention within the context of a semiconductor substrate 10 that is implicitly illustrated within the context of a bulk semiconductor substrate, the instant embodiment is not necessarily so limited. Rather, the instant embodiment may alternatively be practiced using a semiconductor-on-insulator substrate that includes a surface semiconductor layer separated from a base semiconductor substrate by a buried dielectric layer. Within such a semiconductor-on-insulator substrate, the surface semiconductor layer and the base semiconductor substrate may comprise the same or different semiconductor materials within the context of semiconductor material composition, crystallographic orientation, dopant polarity and dopant concentration.

Alternatively, the instant embodiment may also be practiced within the context of a hybrid orientation substrate. A hybrid orientation substrate includes multiple semiconductor regions of different crystallographic orientation.

Semiconductor-on-insulator substrates and hybrid orientation substrates may be fabricated using layer transfer methods, layer lamination methods and separation by implantation of oxygen (SIMOX) methods that are otherwise generally conventional in the semiconductor fabrication art.

The gate dielectric 12 may comprise conventional dielectric materials such as but not limited to oxides, nitrides and oxynitrides of silicon that have a dielectric constant from about 4 to about 20, measured in vacuum. Alternatively, the gate dielectric 12 may comprise generally higher dielectric constant dielectric materials having a dielectric constant from about 20 to at least about 100. Such higher dielectric constant dielectric materials may include, but are not limited to: hafnium oxides, hafnium silicates, titanium oxides, barium-strontium-titantates (BSTs) and lead-zirconate-titanates (PZTs). The gate dielectric 12 may be formed using any of several methods that are appropriate to its material(s) of composition. Included but not limiting are thermal or plasma oxidation or nitridation methods, chemical vapor deposition methods and physical vapor deposition methods. Typically, the gate dielectric 12 comprises a thermal silicon oxide dielectric material that has a thickness that may be in a non-limiting range from about 10 to about 70 angstroms.

The gate electrode material layer 14 may comprise gate electrode materials including but not limited to certain metals, metal alloys, metal nitrides and metal silicides, as well as laminates thereof and composites thereof. The gate electrode material layer 14 may also comprise doped polysilicon and polysilicon-germanium alloy materials (i.e., having a dopant concentration from about 1e18 to about 1e22 dopant atoms per cubic centimeter) and polycide materials (doped polysilicon/metal silicide stack materials). Similarly, the foregoing materials may also be formed using any of several methods. Non-limiting examples include salicide methods, chemical vapor deposition methods and physical vapor deposition methods, such as, but not limited to evaporative methods and sputtering methods. Typically, the gate electrode 18 comprises a doped polysilicon material that has a thickness that may be in a non-limiting range from about 600 to about 2000 angstroms.

The non-directly imageable organic material layer 16 comprises a non-directly imageable organic material. Candidate non-directly imageable organic materials may include, but are not necessarily limited to a near frictionless carbon (NFC) material, a diamond-like carbon (DLC) material, a thermosetting polyarylene ether material (such as, for example, SiLK™ sold by Dow Chemical Co.), or any combination, (e.g., multilayer laminates or composites) thereof. As noted above, the term “polyarylene” is used in this application to denote aryl moieties or inertly substituted aryl moieties which are linked together by bonds, fused rings, or inert linking groups such as, for example, oxygen, sulfur, sulfone, sulfoxide, carbonyl and the like. The non-directly imageable organic material layer 16 may possess anti-reflective coating (ARC) properties, although the non-directly imageable organic material layer typically does not possess anti-reflective coating (ARC) properties. The non-directly imageable organic material layer 16 typically comprises a single layer, although the invention is not necessarily so limited.

The non-directly imageable organic material layer 16 may be formed using any conventional deposition process including, for example and without limitation, chemical vapor deposition (CVD), plasma enhanced chemical vapor deposition (PECVD), evaporation, chemical solution deposition and spin-on coating. A thickness of the non-directly imageable organic material layer 16 may vary depending on the material of the layer, as well as the exact deposition technique that was used in forming the same. Typically, the thickness of the non-directly imageable organic material layer 16 is from about 200 to about 3000 angstroms, with a thickness from about 500 to about 1750 angstroms being even more typical.

The directly imageable inorganic material layer 18 comprises a directly imageable inorganic material. The directly imageable inorganic material may be directly imageable using any of several direct imaging methods. A non-limiting list of candidate direct imaging methods includes electron beam methods, ion beam methods, photon beam methods and other energetic beam methods. Electron beam direct imaging methods are particularly common.

Candidate directly imageable inorganic materials that may be directly imaged using, in particular, electron beam methods include certain types of silicon materials, and in particular silsesquioxane materials, and further more in particular hydrogen silsesquioxane materials. The directly imageable inorganic material layer 18 may be formed from such a silsesquioxane material using methods including but not limited to vapor coating methods, spin coating methods and thermal curing methods. Typically, the directly imageable inorganic material layer 18 comprises a hydrogen silsesquioxane material that has a thickness from about 100 to about 800 angstroms, although such a particular material and a particular thickness do not limit the invention.

FIG. 2 shows the results of imaging and developing the directly imageable inorganic material layer 18 to form a patterned inorganic material layer 18′. The directly imageable inorganic material layer 18 may be imaged to form the patterned inorganic material layer 18′ while using direct imaging and development methods that are generally conventional in the semiconductor fabrication art. As noted above, direct imaging methods include, but are not limited to electron beam methods, ion beam methods, photon beam methods and other related energy beam methods. Development methods are predicated upon a particular inorganic material from which is comprised the directly imageable inorganic material layer 18. Within the context of the instant embodiment, when the directly imageable inorganic material layer 18 comprises a hydrogen silsesquioxane material, and the directly imageable inorganic material layer is imaged using an electron beam exposure, the electron beam exposed directly imageable inorganic material layer 18 is developed using a tetra-methyl ammonium hydroxide (TMAH) solution to form the patterned inorganic material layer 18′.

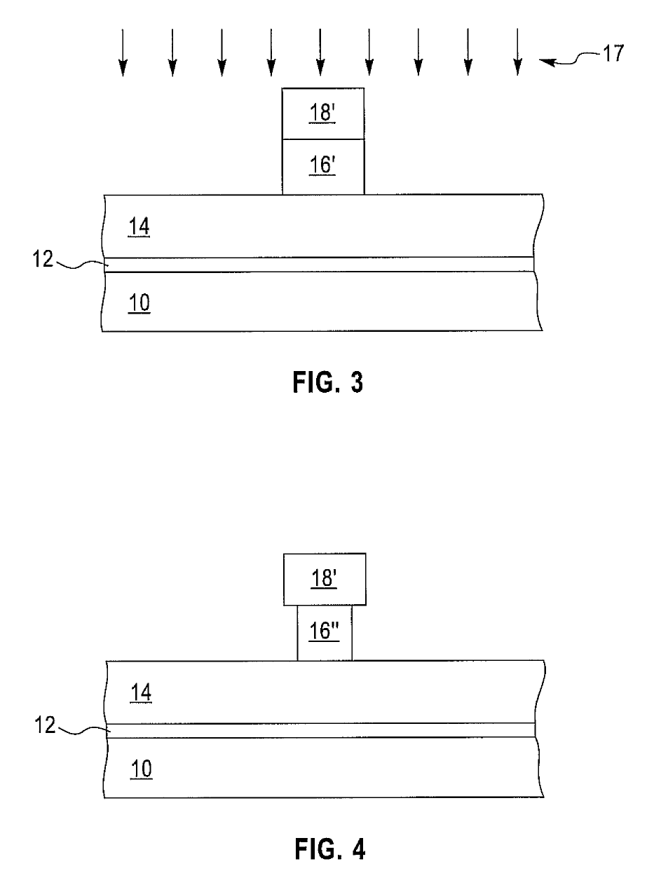

FIG. 3 shows a patterned organic material layer 16′ that results from patterning of the non-directly imageable organic material layer 16 while using the patterned inorganic material layer 18′ as a first etch mask, in conjunction with a first etching plasma 17. Within the instant embodiment when the non-directly imageable organic material layer 16 comprises in particular a near frictionless carbon material, the first etching plasma 17 comprises an oxygen, nitrogen and hydrogen containing etching plasma. Typically, the oxygen, nitrogen and hydrogen containing etching plasma uses: (1) a reactor chamber pressure from about 2 to about 200 mtorr; (2) a substrate 10 and overlying layers temperature from about 10 to about 60 degrees centigrade; (3) a source radio frequency power from about 200 to about 2000 watts and a bias power from about 20 to about 400 watts; (4) and an oxygen flow from about 1 to about 200 standard cubic centimeters per minute, a nitrogen flow rate from about 50 to about 500 standard cubic centimeters per minute and a hydrogen flow from about 10 to about 500 standard cubic centimeters per minute. Occasionally and optionally, a trace amount of a passivating gas may be added for critical dimension (CD) control, at a flow rate from about 1 to about 20 standard cubic centimeters per minute (sccm). Non-limiting examples of such passivating gases include ethylene (C2H4), methane (CH4) and acetylene (C2H2), as well as partially and fully fluorinated analogs of those passivating gases.

FIG. 4 shows a patterned organic material layer 16″ that results from further etching and undercutting of the patterned organic material layer 16′ beneath the patterned inorganic material layer 18′. Such further etching and undercutting may result from a simple over-etching when forming the patterned organic material layer 16′ while using the first etch method that uses the first etching plasma 17. Alternatively, such over-etching may result from an additional adjustment of a particular parameter within the first etch method that uses the first etching plasma 17 for forming the patterned organic material layer 16′ from the non-directly imageable organic material layer 16.

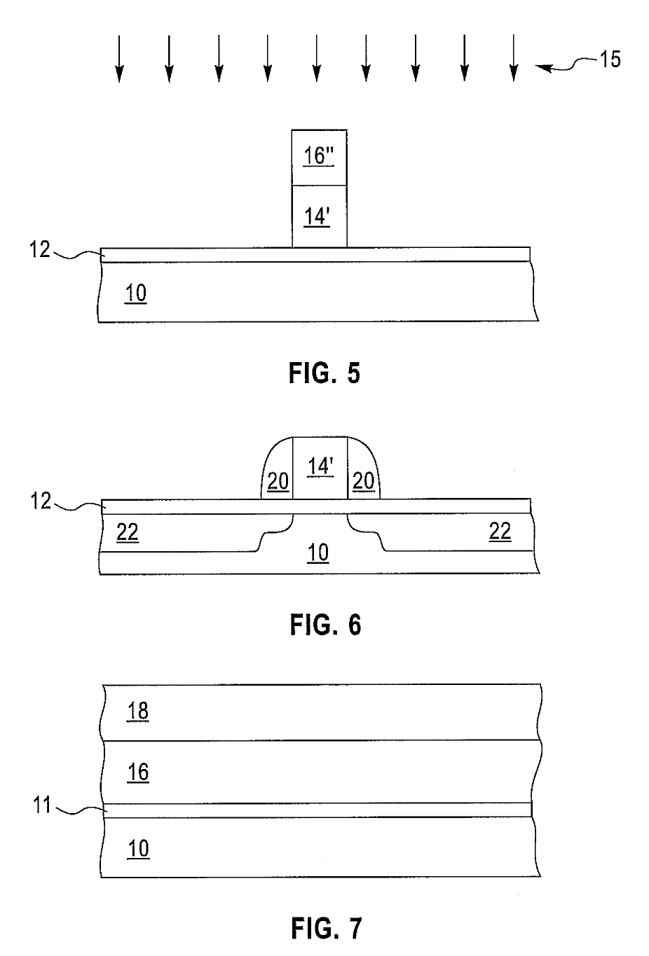

FIG. 5 shows a gate electrode 14′ that results from patterning of the gate electrode material layer 14 while using the patterned organic material layer 16″ as a second etch mask, in conjunction with a second etching plasma 15 that is used within a second etch method. The second etching plasma 15 simultaneously also etches and removes the patterned inorganic material layer 18′ from the patterned organic material layer 16″. The second etching plasma 15 uses an etchant gas composition appropriate to the materials of composition of the gate electrode material layer 14. Typically, but not exclusively, the second etching plasma 15 uses a halogen containing etchant gas composition such as but not limited to a fluorine containing etchant gas composition, a chlorine containing etchant gas composition or a bromine containing etchant gas composition.

When the gate electrode material layer 14 comprises a silicon based gate electrode material, such as but not limited to a polysilicon based gate electrode material, the second etching plasma 15 may use: (1) a reactor chamber pressure from about 2 to about 100 mtorr; (2) a substrate 10 and overlying layers temperature from about 10 to about 60 degrees centigrade; (3) a source radio frequency power from about 100 to about 1000 watts and a bias power from about 20 to about 500 watts; and (4) a hydrogen bromide flow rate from about 50 to about 500 standard cubic centimeters per minute, a chlorine flow rate from about 10 to about 200 standard cubic centimeters per minute, and an oxygen flow rate from about 10 to about 50 standard cubic centimeters per minute.

As is understood by a person skilled in the art, when the patterned inorganic material layer 18′ is formed of a minimum lithographically resolvable linewidth, due to undercutting of the patterned organic material layer 16″ beneath the patterned inorganic material layer 18′ the gate electrode 14′ is formed of less than a minimum photolithographically resolvable linewidth. As a pertinent example, when the patterned inorganic material layer 18′ has a minimum photolithographically resolvable linewidth of about 40 nanometers, the gate electrode 14′ may have a linewidth at least as low as about 20 nanometers. Thus, a method in accordance with the instant embodiment provides sub-lithographic capabilities when forming a patterned layer within a microelectronic structure.

FIG. 6 shows a schematic cross-sectional diagram illustrating the results of further processing of the semiconductor structure whose schematic cross-sectional diagram is illustrated in FIG. 5.

FIG. 6 first shows the results of stripping the patterned organic material layer 16″ from the gate electrode 14′ that is illustrated in FIG. 5, to leave remaining the gate electrode 14′ located upon the gate dielectric 12. The foregoing patterned layer stripping may be effected using stripping methods and materials that are otherwise generally conventional in the semiconductor fabrication art. Such stripping methods and materials may include, but are not limited to wet chemical stripping methods and materials, dry plasma stripping methods and materials and aggregate stripping methods and materials thereof.

FIG. 6 also shows a spacer 20 (i.e., illustrated as a plural layer in cross-section, but intended as a single layer laminated to and peripherally surrounding the gate electrode 14′ in plan view) adjoining sidewalls of the gate electrode 14′.

The spacer 20 may comprise materials including but not limited to conductor materials and dielectric materials. Conductor spacer materials are less common, but are nonetheless known. Dielectric spacer materials are more common. The spacer materials may be formed using methods analogous, equivalent or identical to the methods that are used for forming the gate dielectric 12. The spacer 20 is also formed with the distinctive inward pointing spacer shape by using a blanket layer deposition and anisotropic etchback method. Typically, the spacer 20 comprises a silicon oxide dielectric material, although the invention is not necessarily so limited.

FIG. 6 finally shows a plurality of source/drain regions 22 that are separated by a channel region that is located beneath the gate electrode 14′. The plurality of source/drain regions 22 comprises a generally conventional n conductivity type dopant or p conductivity type dopant appropriate to a polarity of the field effect transistor whose schematic cross-sectional diagram is illustrated in FIG. 6. As is understood by a person skilled in the art, the source/drain regions 22 are formed using a two step ion implantation method. A first ion implantation process step within the method uses the gate electrode 14′, absent the spacer 20, as a mask to form a pair of extension regions each of which extends beneath the spacer 20. A second ion implantation process step uses the gate electrode 14′ and the spacer 20 as a mask to form the larger contact region portions of the pair of source/drain regions 22, while simultaneously incorporating the extension regions. n conductivity type dopant levels or p conductivity type dopant levels are from about 1e19 to about 1e21 dopant atoms per cubic centimeter within each of the plurality of source/drain regions 22. Extension regions within the plurality of source/drain regions 22 may under certain circumstances be more lightly doped than contact regions with the plurality of source/drain regions 22, although such differential doping concentrations are not a requirement of the embodiment.

FIG. 6 shows a schematic cross-sectional diagram of a semiconductor structure that includes a field effect transistor fabricated in accordance with a particular embodiment of the invention that comprises a first embodiment of the invention. A gate electrode 14′ within the field effect transistor may be formed with a reduced line edge roughness (LER) and a reduced line width roughness (LWR) incident to being patterned from a gate electrode material layer in accordance with a method of the instant embodiment. The particular patterning method that is used in accordance with the embodiment uses (i.e., in accordance with FIG. 1) a directly imageable inorganic material layer 18 located upon a non-directly imageable organic material layer 16 in turn located upon a gate electrode material layer 14. Thus, the use of only two material layers for an imaging mask in accordance with the instant embodiment, where only one of the two material layers comprises a directly imageable material, provides for efficiency when forming a gate electrode 14′ from the gate electrode material layer 14. Similarly, the particular materials selections (i.e., an inorganic material layer located upon an organic material layer) in accordance with the invention provide for enhanced etch selectivity that provides for enhancements in line edge roughness and line width roughness when etching the gate electrode 14′ from the gate electrode material layer 14.

FIG. 7 to FIG. 11 show a series of schematic cross-sectional diagrams illustrating the results of progressive stages in fabricating a semiconductor structure in accordance with another embodiment of the invention. This other embodiment of the invention comprises a second embodiment of the invention. FIG. 7 shows a schematic cross-sectional diagram illustrating the semiconductor structure at an early stage in the fabrication thereof in accordance with this second embodiment.

FIG. 7 shows a semiconductor structure related to the semiconductor structure whose schematic cross-sectional diagram is illustrated in FIG. 1, but with an absence of the gate dielectric 12 and the gate electrode material layer 14. The gate dielectric 12 and the gate electrode material layer 14 are in an aggregate replaced by a hard mask layer 11.

The hard mask layer 11 may comprise any of several hard mask materials. Non-limiting examples include oxides, nitrides and oxynitrides of silicon as hard mask materials. Oxides, nitrides and oxynitrides of other elements are not excluded as hard mask materials. The hard mask layer 11 may be formed using methods that are generally conventional in the semiconductor fabrication art. Included in particular are thermal or plasma oxidation or nitridation methods, chemical vapor deposition methods and physical vapor deposition methods. Typically, the hard mask layer 11 comprises a thermal silicon oxide pad dielectric material that has a thickness from about 200 to about 1000 angstroms, in turn having formed and located thereupon a silicon nitride material that has a thickness from about 200 to about 1000 angstroms.

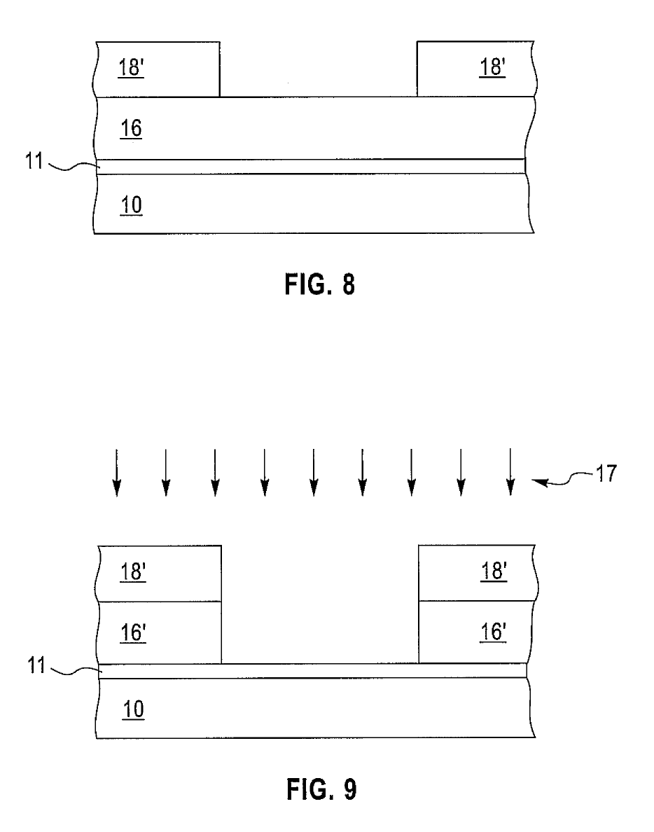

FIG. 8 shows the results of imaging and developing the directly imageable inorganic material layer 18 to form a patterned inorganic material layer 18′. The processing that provides the semiconductor structure whose schematic cross-sectional diagram is illustrated in FIG. 8 from the semiconductor structure whose schematic cross-sectional diagram is illustrated in FIG. 7 corresponds to the processing that yields the semiconductor structure whose schematic cross-sectional diagram is illustrated in FIG. 2 from the semiconductor structure whose schematic cross-sectional diagram is illustrated in FIG. 1.

FIG. 9 shows the results of patterning the non-directly imageable organic material layer to form a patterned organic material layer 16′ while using the patterned inorganic material layer 18′ as a first etch mask, in conjunction with the first etching method that uses the first etching plasma 17. The processing that provides the semiconductor structure whose schematic cross-sectional diagram is illustrated in FIG. 9 from the semiconductor structure whose schematic cross-sectional diagram is illustrated in FIG. 8 corresponds with the processing that provides the semiconductor structure whose schematic cross-sectional diagram is illustrated in FIG. 3 from the semiconductor structure whose schematic cross-sectional diagram is illustrated in FIG. 2.

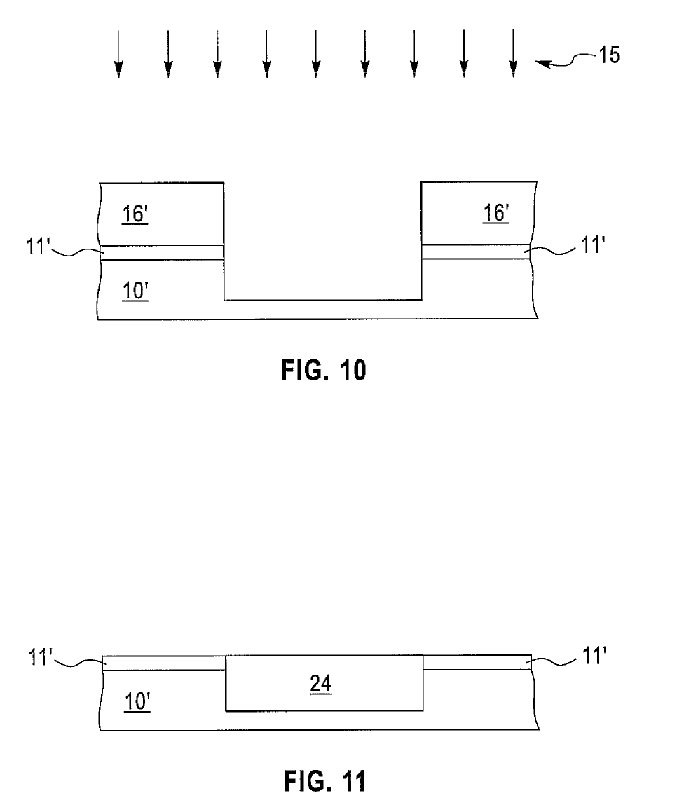

FIG. 10 shows the results of sequentially etching the hard mask layer 11 to provide the hard mask layer 11′ and then also etching the semiconductor substrate 10 to provide an isolation trench within an etched semiconductor substrate 10′. Similarly with the first embodiment, the foregoing etching also strips the patterned inorganic material layer 18′ from the patterned organic material layer 16′. The foregoing etching is undertaken using at least the patterned organic material layer 16′ as a second mask, in conjunction with a second etch method that uses the second etching plasma 15. The processing that provides the semiconductor structure whose schematic cross-sectional diagram is illustrated in FIG. 10 from the semiconductor structure whose schematic cross-sectional diagram is illustrated in FIG. 9 corresponds generally with the processing that yields the semiconductor structure whose schematic cross-sectional diagram is illustrated in FIG. 5 from the semiconductor structures whose schematic cross-sectional diagrams are illustrated in FIG. 3 and FIG. 4.

FIG. 11 first shows the results of stripping the patterned organic material layer 16′ from the patterned hard mask layer 11′ that is illustrated in FIG. 10. This particular processing corresponds in general with the processing that is used in part to provide the semiconductor structure whose schematic cross-sectional diagram is illustrated in FIG. 6 from the semiconductor structure whose schematic cross-sectional diagram is illustrated in FIG. 5.

FIG. 11 finally also shows an isolation region 24 located and formed within the isolation trench. The isolation region 24 comprises a dielectric isolation material. Candidate dielectric isolation materials include, but are not limited to oxides, nitrides and oxynitrides of silicon. Oxides, nitrides and oxynitrides of other elements are not excluded. Typically, the isolation region 24 comprises a liner layer integral thereto and passivating the sidewalls and the floor of the isolation trench. Such a liner layer may comprise, but is not generally limited to, a silicon oxide dielectric material, such as in particular a silicon oxide dielectric material that may be formed incident to thermal oxidation of the etched semiconductor substrate 10′.

The isolation region 24 typically further comprises a dielectric material that is generally less dense than the thermal silicon oxide dielectric material from which is comprised the liner layer that in turn in-part comprises the isolation region 24. This additional dielectric material is typically formed using a blanket layer deposition method and subsequently planarized while using a planarizing method. Planarizing methods may include, but are not necessarily limited to mechanical planarizing methods and chemical mechanical polish planarizing methods. Chemical mechanical polish planarizing methods are particularly common. The particular planarizing methods will typically also use patterned hard mask layer 11′ as a planarizing stop layer.

FIG. 11 shows a schematic cross-sectional diagram of a semiconductor structure in accordance with a second embodiment of the invention. The semiconductor structure includes an isolation region 24 located within an isolation trench within an etched semiconductor substrate 10′. The isolation region 24, and in particular the isolation trench, is formed with a reduced line edge roughness and reduced line width roughness incident to being formed using a lithography method that uses a directly imageable inorganic material layer 18 located upon a non-directly imageable organic material layer 16.

The preferred embodiments of the invention are illustrative of the invention rather than limiting of the invention. Revisions and modifications may be made to methods, materials, structures and dimensions of a directly imageable inorganic material layer and a non-directly imageable organic material layer located thereunder in accordance with the embodiments of the invention to provide several methods in accordance with the invention, further in accordance with the accompanying claims.

1. A method of forming a patterned structure comprising:
successively layering a directly non-imageable organic material layer upon a substrate and a directly imageable inorganic material layer upon the directly non-imageable organic material layer;
directly imaging the directly imageable inorganic material layer to form a patterned inorganic material layer;
using the patterned inorganic material layer as a first mask within a first etch method to etch the directly non-imageable organic material layer to form a patterned organic material layer; and
using at least the patterned organic material layer as a second mask within a second etch to etch the substrate and form a patterned substrate.

2. The method of claim 1 wherein the patterned substrate includes a trench within the substrate.

3. The method of claim 1 wherein the patterned substrate includes a patterned layer that comprises the patterned substrate.

4. The method of claim 3 wherein the patterned layer comprises a material selected from the group consisting of conductor materials, semiconductor materials and dielectric materials.

5. The method of claim 1 wherein the directly imageable inorganic material layer comprises a silicon containing material.

6. The method of claim 1 wherein the directly imageable inorganic material layer comprises a silsesquioxane material.

7. The method of claim 1 wherein the non-directly imageable organic material layer comprises a material selected from the group consisting of a near frictionless carbon material, a diamond-like carbon material, a thermosetting polyarylene ether and multilayers thereof.

8. The method of claim 1 wherein the non-directly imageable organic material layer possesses anti-reflective coating properties.

9. The method of claim 1 wherein the non-directly imageable organic material layer does not possess anti-reflective coating properties.

10. The method of claim 1 further comprising recessing the patterned organic material layer beneath the patterned inorganic material layer prior to using the at least the patterned organic material layer as a second mask within a second etch to etch the substrate and form the patterned substrate.

11. The method of claim 10 wherein the recessing provides the patterned structure with a linewidth less than about 20 nm.

12. The method of claim 1 wherein the using the patterned inorganic material layer and the using the patterned organic material layer provides the patterned structure with at least one of a line edge roughness and a line width roughness less than about 2 nm.

13. A method of forming a gate electrode comprising:
successively layering a non-directly imageable organic material layer over a gate electrode material layer located over a substrate and a directly imageable inorganic material layer upon the non-directly imageable organic material layer;
directly imaging the directly imageable inorganic material layer to form a patterned inorganic material layer;
using The patterned inorganic material layer as a first mask within a first etch method for etching The directly non-imageable organic material layer to form a patterned organic material layer; and
using at least the patterned organic material layer as a second etch mask within a second etch method for etching the gate electrode material layer to form a gate electrode.

14. The method of claim 13 wherein the directly imageable inorganic material layer comprises a silsesquioxane material.

15. The method of claim 13 wherein the non-directly imageable organic material layer comprises a material selected from the group consisting of a near frictionless carbon material, a diamond-like carbon material, a thermosetting polyarylene ether and multilayers thereof.

16. The method of claim 13 wherein the non-directly imageable organic material layer does not possess anti-reflective coating properties.

17. A method of forming an isolation trench comprising:
successively layering a directly non-imageable organic material layer upon a semiconductor substrate and a directly imageable inorganic material layer upon the directly non-imageable organic material layer;
directly imaging the directly imageable inorganic material layer to form a patterned inorganic material layer;
using the patterned inorganic material layer as a first mask within a first etch method to etch the directly non-imageable organic material layer to form a patterned organic material layer; and
using at least the patterned organic material layer as a second mask within a second etch method to etch the semiconductor substrate to form an isolation trench within the semiconductor substrate.

18. The method of claim 17 wherein the directly imageable inorganic material layer comprises a silsesquioxane material.

19. The method of claim 17 wherein the non-directly imageable organic material layer comprises a material selected from the group consisting of a near frictionless carbon material, a diamond-like carbon material, a thermosetting polyarylene ether and multilayers thereof.

20. The method of claim 17 wherein the non-directly imageable organic material layer does not possess anti-reflective coating properties.
